(19) United States
(12) Patent Application Publication
(10) Pub. No.: US 2002/0177960 A1
(43) Pub. Date: Nov. 28, 2002

(54) System and method for measuring vehicle engine oil level

(76) Inventor: Axel H. Berndorfer, El Paso, TX (US)

Correspondence Address: DELPHI TECHNOLOGIES, INC., Legal Staff, P.O. Box 5052, Mail Code: 480-414-420, Troy, MI, 48007-5052, US

(21) Appl. No.: 09/864,968

(22) Filed: May 24, 2001

(51) Int. Cl. G01L 7/00; G01N 11/00; G01F 17/00; G06F 19/00; G01F 23/00

(52) U.S. Cl. 702/50

(57) ABSTRACT

A method for measuring vehicle engine oil level includes determining when a vehicle is being fueled and while the vehicle is being fueled, or immediately thereafter, measuring the level of oil in a vehicle oil pan. Since the parking areas around most gas pumps are level, the vehicle and its oil pan will also be level. Thus, the oil level measured is most accurate.

### TECHNICAL FIELD

The present invention relates generally to engine oil sensors.

### BACKGROUND OF THE INVENTION

Many modern motor vehicles are equipped with sensors that sense the level of oil in a vehicle oil pan. Typically, these oil level sensors are calibrated to be accurate when the vehicle is in a level position, e.g, parked on a level surface. Due to complex oil pan designs and limited freedom to place the sensor in the oil pan, the accuracy of the sensor can suffer greatly if the vehicle is not in a level position when the oil level within the oil pan is measured. Unfortunately, as recognized by the present invention, the position of the vehicle is unknown to the sensor. Thus, if the vehicle is, e.g., parked on an incline or a curb, the oil pan will not be level and the measurement of the oil level will be inaccurate.

Systems have been provided that take multiple readings and then average them in order to compensate for inaccurate readings. Alternatively, systems have been provided in which the level sensor is placed as close to the centroid of the oil pan as possible. Either of these solutions can be quite complex and expensive.

As such, the present invention has recognized these prior art drawbacks, and has provided the below-disclosed solutions to one or more of the prior art deficiencies.

### SUMMARY OF THE INVENTION

A method for measuring vehicle engine oil level includes determining whether a vehicle is being fueled, and if so, measuring an oil level in an oil pan. In a preferred embodiment, it is determined whether the oil level is below a predetermined threshold. If so, it is indicated that oil must be added to the oil pan.

In one aspect of the present invention, it is determined whether the vehicle is being fueled by determining whether a fuel tank flap is opened and subsequently, closed.

In another aspect of the present invention, it is determined whether the vehicle is being fueled by determining whether a fuel level within a vehicle fuel tank has increased.

In still another aspect of the present invention, a system for measuring vehicle engine oil level includes a vehicle having a microprocessor therein. The microprocessor includes a program for determining when the vehicle is being fueled and if so, measuring an oil level within the oil pan.

The present invention will now be described, by way of example, with reference to the accompanying drawings, in which:

### BRIEF DESCRIPTION OF THE DRAWINGS

FIG. 1 is a block diagram of a system for measuring vehicle engine oil level;

FIG. 2 is a flow chart of a method for measuring vehicle engine oil level; and

FIG. 3 is a flow chart of an alternate method for measuring vehicle engine oil level.

### DESCRIPTION OF AN EMBODIMENT OF THE INVENTION

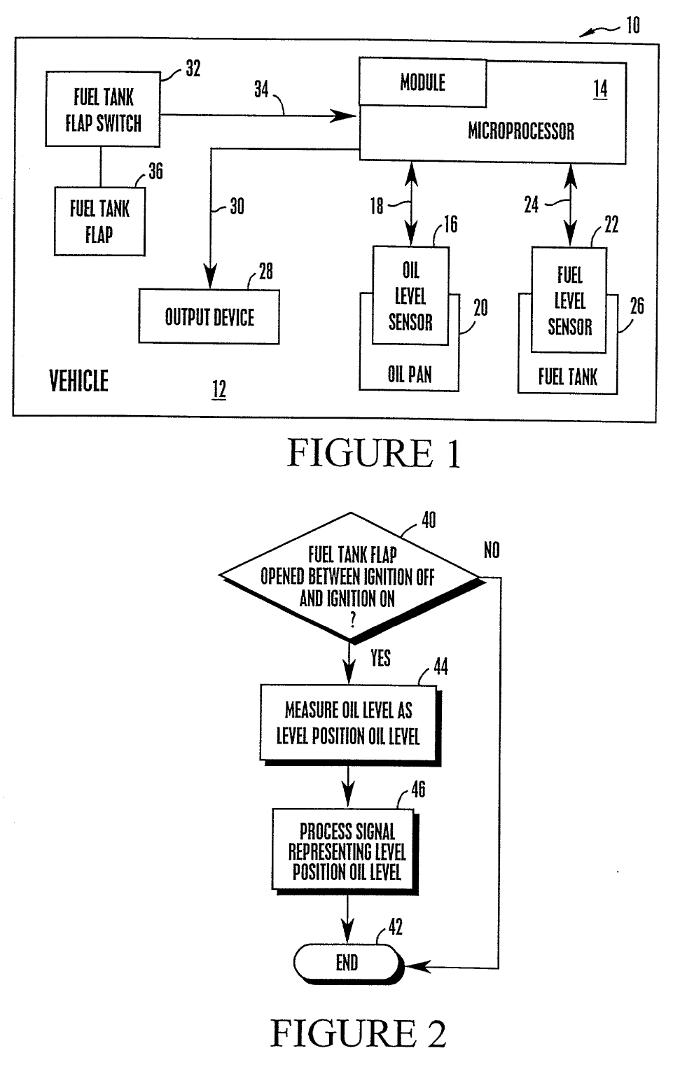

Referring initially to FIG. 1, a system for measuring the vehicle engine oil level is shown and generally designated 10. FIG. 1 shows that the system includes a vehicle 12 in which a microprocessor 14 is installed. It is to be appreciated that the microprocessor 14 can be an onboard chip such as, vehicle onboard electronics. Moreover, it is to be appreciated that the microprocessor 14 can be a chip within the sensor, described below.

As shown in FIG. 1, an oil level sensor 16 is connected to the microprocessor 14 via electric line 18. The oil level sensor 16 is installed in an oil pan 20 such that the level of oil therein can be monitored. Additionally, the system 10 includes a fuel level sensor 22 that is connected to the microprocessor 14 via electric line 24. The fuel level sensor 22 is installed in a fuel tank 26 such that the level of fuel therein can be monitored.

FIG. 1 shows an output device 28 that is connected to the microprocessor 14 via electric line 30. It is to be appreciated that the output device 28 can be an audible warning device, e.g., a buzzer or audible alarm. The output device 28 can also be a visual warning device, e.g., an add-oil indicator or a change oil indicator. Moreover, it is to be appreciated that the output device 28 can be an oil level indicator that provides a visual display of the level of oil within the oil pan.

As shown in FIG. 1, a fuel tank flap switch 32 is connected to the microprocessor 14 via electrical line 34. In a preferred embodiment, the fuel tank flap switch 32 is mechanically coupled to a fuel tank flap 36, i.e., the little door that covers the fuel tank fill cap, and sends a signal to the microprocessor when the fuel tank flap 36 is opened, e.g., while the vehicle is being fueled. It is to be appreciated that the tank flap switch 32 can be a non-contact device, e.g., one that employs a magnet and a magnetic field sensor. As shown in FIG. 1, the system further includes a control module 38 within the microprocessor 14.

The microprocessor 14 includes a series of computer-executable instructions, as described below, which will allow the microprocessor 14 to determine when the vehicle has been fueled and measure the oil level in the oil pan 20 to get the most accurate measurement thereof. These instructions may reside, for example, in the module 38 of the microprocessor 14, which, when programmed with the present logic, establishes a computer program product.

Alternatively, the instructions may be contained on a data storage device with a computer readable medium, such as a computer diskette having a data storage medium holding computer program code elements. Or, the instructions may be stored on a DASD array, magnetic tape, conventional hard disk drive, electronic read-only memory, optical storage device, or other appropriate data storage device. In an illustrative embodiment of the invention, the computer-executable instructions may be lines of compiled C++ compatible code. As yet another equivalent alternative, the logic can be embedded in an application specific integrated circuit (ASIC) chip or other electronic circuitry.

Referring to FIG. 2, the vehicle engine oil measuring logic is shown. Commencing at decision diamond 40, it is determined whether the fuel tank flap 36 is opened between the vehicle ignition being turned off and then turned on as indicated by a signal from the fuel tank flap switch 32. If not, the logic ends at state 42. If the fuel tank flap 40 is opened in between the vehicle ignition being turned off and then back on, the logic proceeds to block 44 where the oil level is measured as the level position oil level. It is to be appreciated that the situation described above, where the tank flap 36 is opened in between the vehicle ignition being turned off and then turned on, most likely indicates that the vehicle has just been fueled. As such, measuring the oil level immediately thereafter provides the most accurate measurement of the oil level in the oil pan 20 since the vehicle is likely to be on a level surface.

Continuing the description of the logic, at decision diamond 46, a signal from the oil level sensor 16 representing the level position oil level is processed by the microprocessor. It is to be appreciated that the level position oil level signal can be compared to a predetermined minimum threshold to determine if the vehicle may be operated without the risk of harm to the engine due to a low oil level. If the level position oil level is below the predetermined minimum threshold, a signal can be sent to the output device 28, e.g., an add-oil indicator, to warn a driver that the oil level is low. Moreover, the signal can be processed and sent to an output device 28, e.g., an oil level indicator, so that a visual representation of the level of oil in the oil pan 20 can be provided to the driver or operator of the vehicle 12. Thereafter, the logic ends at state 42.

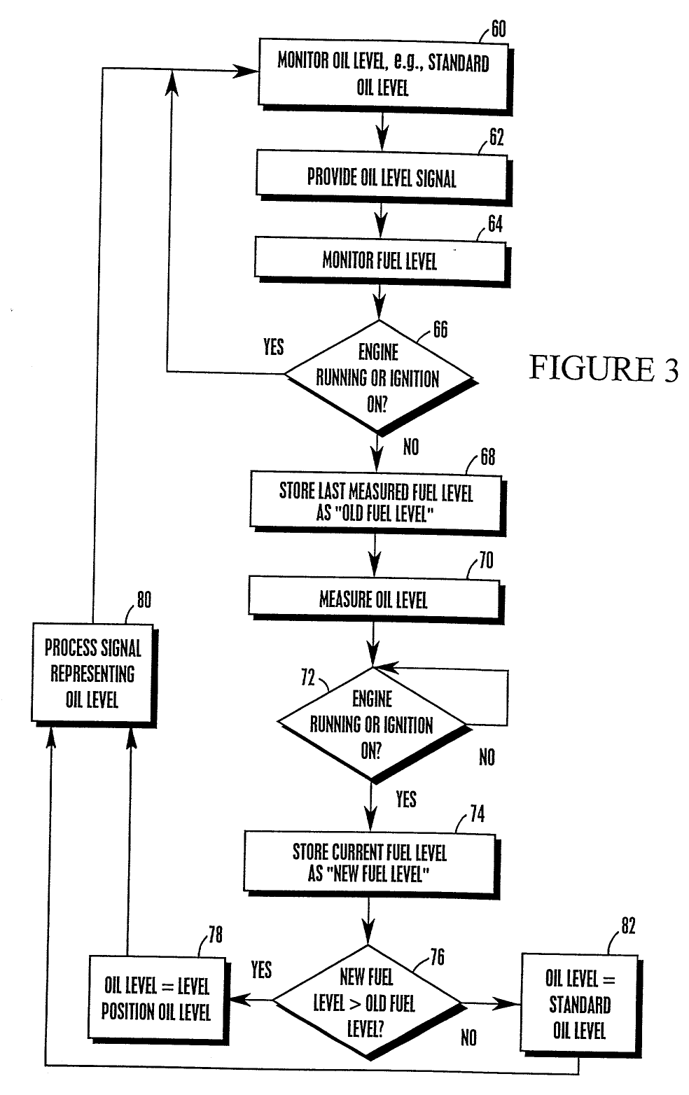

Referring to FIG. 3, an alternate embodiment of the vehicle engine oil measuring logic is shown. Commencing at block 60, the oil level is monitored. At block 62, an oil level signal is provided to the microprocessor 14 which, in turn, provides a signal to an output device 28, e.g., an oil level indicator. Moving to block 64, the fuel level is monitored. Thereafter, at decision diamond 66, it is determined whether the engine is running or the vehicle ignition is on. If yes, the logic returns to block 60 where the oil level is monitored. The logic then continues as described above. If, at decision diamond 66, the engine is not running or the ignition is off, the logic proceeds to block 68 where the last measured fuel level is stored as the “Old Fuel Level.” At block 70, the oil level is measured.

Moving to decision diamond 72, it is determined whether the engine is running or the ignition is on. If not, the logic repeats the determination at decision diamond 72. If the engine is running or the ignition is on, the logic continues to block 74 where the current fuel level is stored as the “New Fuel Level.”

Proceeding to decision diamond 76, it is determined whether the New Fuel Level is greater than the Old Fuel Level. If so, the logic moves to block 78 where the oil level is stored as the level position oil level. Thereafter, the logic proceeds to block 80 where the signal representing the level position oil level is processed by the microprocessor, e.g., as described above in conjunction with FIG. 2. The logic then returns to block 60 and continues as described above.

Returning to decision diamond 76 if the New Fuel Level is less than the Old Fuel Level, the logic proceeds to block 82 where the oil level is stored as the standard oil level, i.e., the oil level measured while the vehicle is in motion or while the vehicle is on an unknown surface and then corrected by an algorithm. Then, the logic moves to decision diamond 80 and continues as described above.

With the configuration of structure and logic described above, it is to be appreciated that the system and method for measuring vehicle engine oil level measures the engine oil immediately after the vehicle has been re-fueled. Since the parking areas adjacent to the fuel pumps at nearly every gas station are approximately level, measuring the oil level during or immediately after the vehicle has been re-fueled relatively easily increases the accuracy of the oil level measurement.

While the particular SYSTEM AND METHOD FOR MEASURING VEHICLE ENGINE OIL LEVEL as herein shown and described in detail is fully capable of attaining the above-described objects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it is to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. section 112, sixth paragraph, unless the element is expressly recited using the phrase “means for.”

We claim:

1. A method for measuring vehicle engine oil level, comprising the acts of:
determining whether a vehicle is being fueled; and
measuring an oil level in an oil pan in response to the determining act.

2. The method of claim 2, further comprising the act of:
determining whether the oil level is below a predetermined threshold; and
at least partially based thereon, indicating that oil must be added to the oil pan.

3. The method of claim 1, wherein it is determined whether the vehicle is being fueled at least partially by:
determining whether a fuel tank flap is opened.

4. The method of claim 1, wherein it is determined whether the vehicle is being fueled at least partially by:
determining whether a fuel level within a vehicle fuel tank has increased.

5. A system for measuring engine oil level, comprising:
a microprocessor including a program for determining when a refueling is being undertaken and measuring an oil level within the oil pan in response to the determining act.

6. The system of claim 5, wherein an engine is in a vehicle including a fuel tank flap, and a fuel tank flap switch is connected to the fuel tank flap, the switch sending a signal to the microprocessor, the program of the microprocessor comprising:
logic means for determining whether the fuel tank flap is opened; and
logic means for measuring the oil level in response to the determining act.

7. The system of claim 6, further comprising an output device connected to the microprocessor, the program further comprising:
logic means for processing a signal representing the oil level; and
logic means for sending a signal to the output device.

8. The system of claim 7, wherein the output device is an add-oil indicator.

9. The system of claim 7, wherein the output device is an oil level indicator.

10. The system of claim 5, further comprising a fuel level sensor in communication with a vehicle fuel tank, the program of the microprocessor comprising:
logic means for determining whether a fuel level within the vehicle fuel tank has increased; and
logic means for measuring the oil level in response to the determining act.

11. The system of claim 10, further comprising an output device connected to the microprocessor, the program further comprising:
logic means for processing a signal representing the oil level; and
logic means for sending a signal to the output device.

12. The system of claim 11, wherein the output device is an add-oil indicator.

13. The system of claim 11, wherein the output device is an oil level indicator.
